(19) United States
(12) Patent Application Publication
(10) Pub. No.: US 2018/0339357 A1
(43) Pub. Date: Nov. 29, 2018

(54) WIRE FEEDER

(71) Applicant: Illinois Tool Works Inc., Glenview, IL (US)

(72) Inventors: Mark Ulrich, New London, WI (US); Jeffrey Lenz, Appleton, WI (US); Divya Natarajan, Appleton, WI (US); Jim Kimball, Appleton, WI (US)

(21) Appl. No.: 15/606,272

(22) Filed: May 26, 2017

(51) Int. Cl. B23K 9/12; B23K 9/133

(52) U.S. Cl. CPC B23K 9/125; B23K 9/1336; B65H 57/18; B23K 9/133; B23K 9/124

(57) ABSTRACT

Systems and methods of an improved wire feeder for a welding system are disclosed. The wire feeder includes a linear motor configured to drive electrode wire from a wire supply.

### BACKGROUND

Gas metal arc welding (GMAW), which includes metal inert gas (MIG) welding and metal active gas (MAG) welding, is a welding process where an electric arc forms between a consumable electrode wire and a metal workpiece. Heat generated by the arc causes the electrode wire to melt and create a weld bead on the workpiece(s). A wire feed drive system, or wire feeder, is used to drive the electrode wire from a wire supply (e.g., a reel or drum) to a welding-type tool (e.g., a welding-type torch) to perform the welding operation.

Conventionally, wire feeders for welding-type systems employ mechanical motors to feed electrode wire to a welding-type torch. Such motors employ rollers or other means to make physical contact with the electrode wire to force the wire forward. The rollers and other moving parts of the motor tend to wear, requiring frequent maintenance and replacement, which can be costly. Such contact can also damage the wire.

### SUMMARY

Systems and methods for an improved wire feeder for a welding system are disclosed. In particular, a wire feeder is provided that includes a linear motor configured to drive electrode wire from a wire supply, substantially as illustrated by and described in connection with at least one of the figures, as set forth more completely in the claims.

### BRIEF DESCRIPTION OF THE DRAWINGS

FIG. 1 is an example wire feeder system, in accordance with aspects of this disclosure.

FIG. 2 is a cross-sectional view of selected components of a wire feeder, in accordance with aspects of this disclosure.

FIG. 3 is a flowchart illustrating an example method of operating the wire feeder of FIGS. 1 and 2, in accordance with aspects of this disclosure.

The figures are not necessarily to scale. Where appropriate, similar or identical reference numbers are used to refer to similar or identical components.

### DETAILED DESCRIPTION

Examples of conventional wire feeders include a motor or mechanism that drives the wire to and/or from a welding-type tool by one or more rollers, gears, or other suitable means. The rollers are configured to contact a wire to drive the through a wire-guide. The motor and rollers contain a large number of components that, due, to the constant movement of the motor and contact between moving parts, are subject to wear. Additionally, environmental contaminants can build-up in joints, gears, etc., accelerating the need for maintenance.

The disclosed wire feeder includes a linear motor employing a plurality of windings (e.g., electromagnets) to advance a wire without the use of physical contact and force. Generally, a linear motor employs a magnetic field generator to move a conductor and/or a magnet by inducing eddy currents in the conductor. A magnetic field resulting from the eddy currents will oppose the magnetic field from the magnetic field generator, creating a force within the conductor sufficiently strong to move the conductor without requiring physical and/or electrical contact between the linear motor and the conductor.

As described herein, the linear motor of the wire feeder advances the electrode wire by generating a series of sequential magnetic fields in a single direction along the length of the wire feeder. In response to the magnetic fields, a three is generated in the wire sufficient to move the wire by the linear motor, for example through a wire guide. The linear motor does not have moving parts. Rather, the linear motor is activated by application of sequential currents to the plurality of windings, which generates the magnetic fields to drive the wire. The linear motor can adjust the speed by which the wire is forced through the wire feeder by, for example, adjusting a rate of activation of the sequential magnetic fields in order to control the speed of the wire advancing through the wire feeder. Accordingly, the motor does not make physical contact with the wire, reducing stress on both the wire and the components of the motor. Moreover, the lack of moving parts requires less maintenance and will attract less environmental contamination. The resulting improved wire feeder provides a simple solution to the issues raised by the use of conventional wire feeders.

A welding-type system, as used herein, includes any device capable of supplying power suitable for welding, plasma cutting, induction heating, CAC-A and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the terms “first” and “second” may be used to enumerate different components or elements of the same type, and do not necessarily imply any particular order. For example, while in some examples a first compartment is located prior to a second compartment in an airflow path, the terms “first compartment” and “second compartment” do not imply any specific order in which air flows through the compartments.

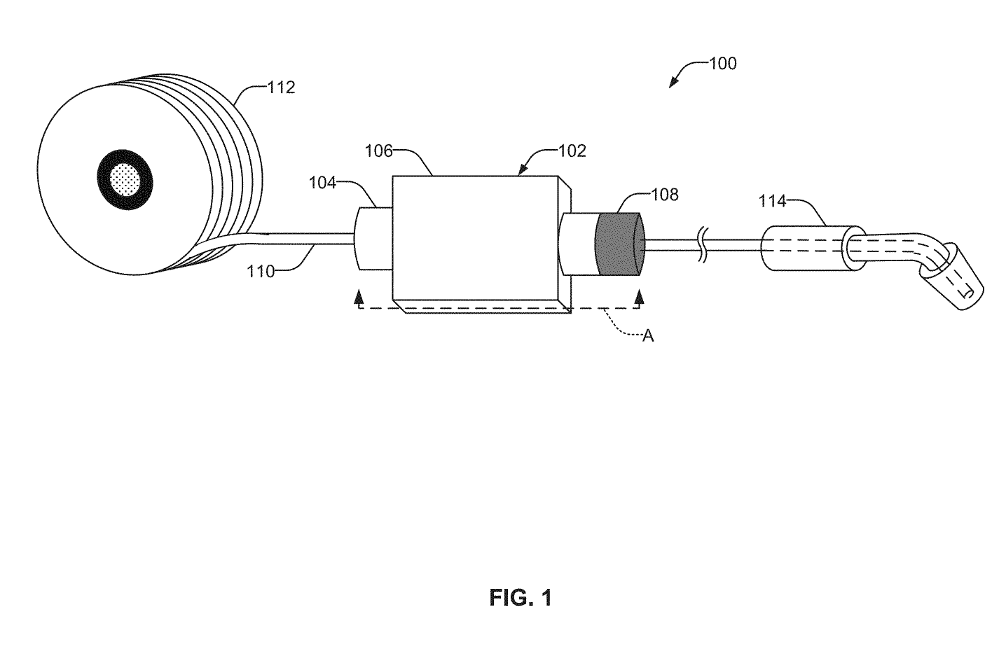

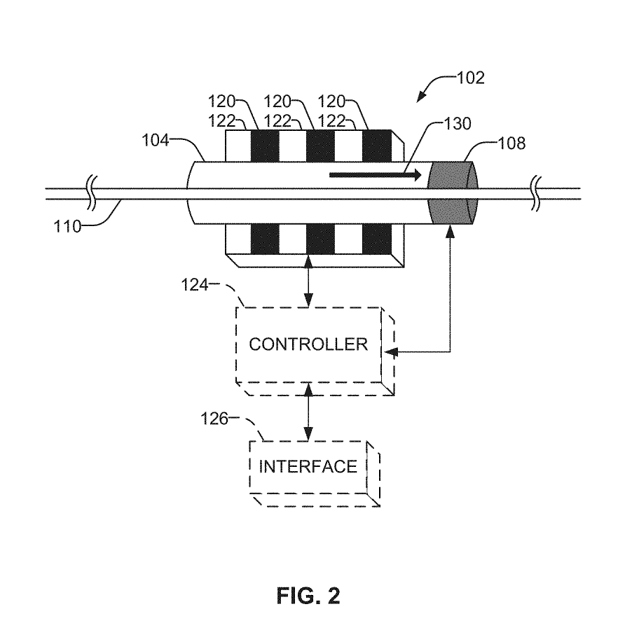

FIG. 1 illustrates an example wire feeder 102 for a welding system 100, in accordance with the disclosed examples. As provided herein, the wire feeder 102 can be integrated with or located remote from a welding-type power supply (e.g., contained in an accessory housing, integrated with a torch, etc.). In the example of FIG. 1, the wire feeder 102 is a linear motor configured to advance an electrode wire 110 via a plurality of windings (see, e.g., FIG. 2). The electrode wire 110 can include any type of wire employed in a welding-type operation, such as solid core and flux core, and can be made of a variety of materials, such as steel, copper, aluminum, as well as alloys of these and other metals.

In some examples, the wire feeder 102 is linear motor that, instead of producing a rotational torque, produces a linear force along the length of the motor. In an example, the linear motor generates a force in response to a moving linear magnetic field to drive the electrode wire 110. The magnetic field is induced by activation of a plurality of windings housed within an enclosure 106. In this example, the metallic electrode wire 110 is a conductor placed within the influence of the magnetic field. In response to the magnetic field, eddy currents are induced in the electrode wire 110 creating an opposing magnetic field in accordance with Lenz's law. The electrode wire 110 is thus propelled forward in response to the force generated by repulsion of the opposing magnetic fields.

As the electrode wire 110 is driven though the linear motor and/or a wire guide 104, the electrode wire 110 is drawn from a wire supply 112, such as a spool. The electrode wire 110 traverses the wire feeder 102 to provide the wire 110 to a welding-type tool, such as welding-type torch 114. The electrode wire 110 can be driven through the wire guide 104, which can guide and protect the wire during a welding operation. In some examples, the wire guide 104 is integrated within the wire feeder 102, whereas in other examples the wire guide 104 can be additionally or alternatively located at one or more locations along the path of the electrode wire 110, from the spool 112 through the welding-type tool 114 itself. Additionally or alternatively, a wire feed speed sensor 108 can be employed. The wire feed speed sensor 108 can be integrated with the wire feeder 102 or located at another location suitable to monitor the speed and/or amount of wire advancing through the wire feeder 102.

FIG. 2 shows a cross-sectional view of the wire feeder 102 along the line “A”, as illustrated in FIG. 1. Within the enclosure 106 are a plurality of windings 120, 122. As illustrated in FIG. 2, windings 120 are wound in an alternating manner, relative to the windings 122, along the length of the linear motor and/or the wire guide 104. Each winding 120, 122 is electrically connected to a controller 124. The controller 124 can execute commands and/or instructions, and can include digital and analog circuitry, discrete or integrated circuitry, microprocessors, ASICs, FPGAs, etc., and software, hardware and firmware, located on one or more boards, used to control all or part of a welding-type system including the wire feeder 102.

The controller 124 is configured to induce magnetic fields in an alternating sequence. The controller 124 activates one or more windings windings 120) at a first time, and then activates one or more windings (e.g., windings at a second time. The controller 124 can control application of a first current to winding 120 to induce a first magnetic field at the first time. At the second time, the controller 124 is configured to apply a second current to winding 120 to induce a second magnetic field along the wire guide in the direction of travel. As the electrode wire 110 experiences eddy currents induced from the sequential application of the first and second magnetic fields, the resulting force advances the electrode wire 110 in the forward direction 130 (e.g., a feeding direction). Although shown advancing the wire in the forward direction 130, changing (e.g., reversing) the direction and sequence of current to the windings 120, 122 can cause the electrode wire to move in a reverse direction (e.g., wire retraction) opposite direction 130.

While shown directly coupled to the windings 120, 122 and providing sufficient power to advance and/or retract the electrode wire 110, in some examples the controller 124 controls application of current to the windings 120, 122 by selectively connecting the windings 120, 122 to one or more power sources (e.g., current sources) via corresponding switching elements. Example switching elements include power transistors, relays, or the like,

In an example, the controller 124 is further connected to the wire speed sensor 108. The wire speed sensor 108 is configured to monitor and/or measure the speed of the advancing electrode wire 110, by the use of a tachometer. A length of wire traversing the wire feeder 102 can also be measured, using a digital or analog rotary encoder and/or a mechanical length measuring meter, for example. The wire speed sensor 108 can provide this information to the controller 124 as a e feed speed signal. This signal can be used to adjust a rate of activation of the windings 120, 122 in order to control the speed of the wire advancing through the wire feeder 102.

Additionally or alternatively, the controller 124 can he connected to one or more interfaces 126 to provide instructions or commands as to the operation of the wire feeder 102. The interface 126 may he integrated with the wire feeder 102, may be located remotely, and/or integrated with another device (e.g., a welding-type power supply, a computing system, etc.). In some examples, the interface 126 can be a graphical user interface (GUI) configured to display operating parameters and provide a user with controls to operate the wire feeder 102. In examples, the interface 126 is operatively connected to a processor, which can be linked to one or more devices to coordinate functions of the wire feeder 102. In such an example, the interface 126 and/or the processor may communicate with a welding-type power supply (not shown) to respond to one or more events, such as advancing the electrode wire 110 in response to commencement of a welding operation and halting advancement, of the electrode wire 110 in response to ending a welding operation.

In the example of FIG. 2, the windings 120, 122 are represented as surrounding the wire guide housing 104. In some examples, the windings 120, 122 can be placed on a single side of the wire guide housing 104, on opposite sides with a gap in between opposing windings), or other possible configurations capable of the same or similar effect. The wire guide housing 104 can prevent contact between the electrode wire 110 and the components of the wire feeder 102, such as the windings 120, 122. The wire guide housing 104 can be constructed of a material permeable to magnetic fields that allows free movement of the electrode wire 110, such as a polymer. Furthermore, FIG. 2 illustrates three sets of each windings 120, 122. The wire feeder 102 can operate with as few as one of each winding 120, 122, and with as many windings 120, 122 as desired for a particular implementation. For instance, a greater number of windings 120, 122 will he able to generate a stronger induced force, whereas fewer windings 120, 122 will result in a shorter length of the wire guide 104.

In some examples, the linear motor can be located at one or more positions along the path of the wire from the spool 112 to the welding-type tool 114. For example, one or more wire feeders 102 can be located with the spool 112, with a power supply, along the length cabling, and/or near or integrated with the welding-type tool 114. In examples, the welding-type tool 114 is a spool gun-type torch which can include an integrated wire supply. In the example of a spool gun, the wire feeder 102 may be attached to or housed within the torch itself. Moreover, the wire feeder 102 can be configured in a variety of shapes and/or sizes, depending on the particular application.

In examples, two or more wire feeders 102 can be employed to, for instance, drive the electrode wire 110 over long distances. In some examples, two or more wire feeders 102 are controlled to selectively drive the electrode wire 110 in opposing directions. This action can cause the electrode wire 110 to stop, such that the wire 110 is not advancing or retracting, but held in place. The controller 124 can be configured to control the plurality of wire feeders 102 individually or together, depending on the application.

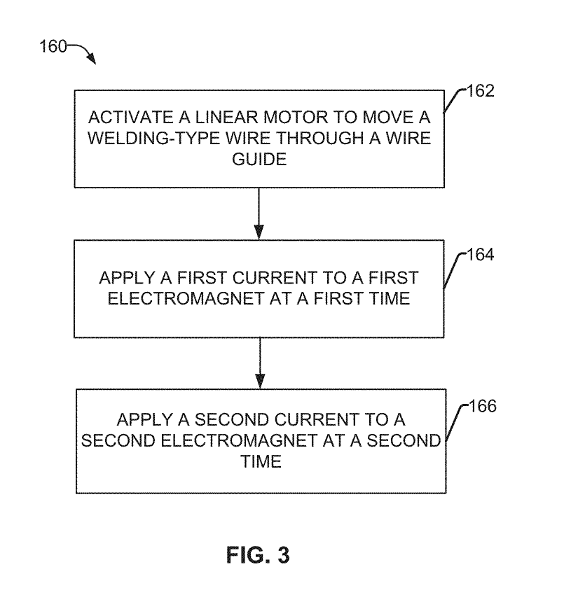

FIG. 3 is a flowchart illustrating an example method 160 which may be to advance or retract a welding-type wire (e.g., electrode wire 110) of a welding-type system. At block 162, a linear motor is activated to move a welding-type wire through a wire guide. At block 164, a first current is applied to a first winding or set of windings at a first time. For example, a controller (e.g., controller 124 of FIG. 2) can control a power supply to apply a first current to a first set of windings arranged at a first location along a wire guide (e.g., wire guide). A first magnetic field results from the first current, which induces eddy currents in the wire. A magnetic field is generated within the wire in a direction opposite the first magnetic field generated by the first winding. A force results as the two magnetic fields oppose one another, propelling the wire forward. At block 166, a second current is applied to a second winding or set of windings at a second time. Similarly, the controller can control the power supply to apply the second current to the second set of windings arranged at a second location along the wire guide. The second current, and the magnetic field accompanying the eddy currents generated in the wire in response, force the wire further along the wire guide. As a result of the alternating sequence of the first and second currents, the welding-type wire is advanced through the wire guide. Further, the timing between control of the first and second currents can be selected to advance and/or retract the wire at a desired speed through the wire feeder. Additionally or alternatively, the example method 160 may be stored on the any suitable non-transitory machine readable media as a set of instructions to be executed by a processor controller 124 of FIG. 2).

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may he made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A wire feeder for a welding system, comprising a linear motor configured to drive electrode wire from a wire supply.

2. The system of claim 1, wherein the linear motor comprises a plurality of windings arranged along a length of a wire guide.

3. The system of claim 2, further comprising a controller configured to control the linear motor.

4. The system of claim 3, wherein the controller is configured to selectively apply current to the plurality of windings to generate magnetic fields along the length of the linear motor.

5. The system of claim 3, wherein the plurality of windings comprises a first winding and a second winding arranged along the length of the linear motor.

6. The system of claim 5, wherein the controller is configured to:
apply a first current to the first winding at a first time to induce a first magnetic field; and
apply a second current to the second winding at a second time to induce a second magnetic field.

7. The system of claim 6, wherein the controller is further configured to apply the first and second currents in an alternating sequence such that a magnetic field at the wire generates a force to move the wire along the linear motor.

8. The system of claim 3, wherein the controller is configured to:
receive a wire feed speed signal; and
adjust a speed of the linear motor based on the signal.

9. The system of claim 3, further comprising a wire feed speed sensor configured to generate a signal representative of the wire feed speed, the controller configured to control the linear motor based on the signal.

10. The system of claim 9, wherein the wire feed speed sensor comprises a tachometer.

11. The system of claim 1, further comprising a wire guide that includes a housing configured to prevent physical contact between the wire and the linear motor and to guide and protect the wire.

12. The system of claim 1, wherein the housing comprises a polymer material.

13. A method comprising activating a linear motor to move a welding-type wire through a linear motor toward a welding-type torch connector.

14. The method of claim 13, further comprising selectively applying current, by a controller, to a plurality of windings of the linear motor to generate magnetic fields along a length of the linear motor.

15. The method of claim 14, further comprising:
applying, by a controller, a first current to a first winding of the plurality of windings at a first time to induce a first magnetic field; and
applying, by the controller, a second current to a second winding of the plurality of windings at a second time to induce a second magnetic

16. The method of claim 15, further comprising applying, by the controller, the first and second currents in an alternating sequence to generate a force to move the wire through the linear motor.

17. The method of claim 13, further comprising:
receiving, at a controller, a wire feed speed signal; and
adjusting, by the controller, a speed of the linear motor based on the signal.

18. The method of claim 13, further comprising calculating, at the controller, a length of the welding-type wire moving through the linear motor.

19. A wire feeder for a welding-type system, comprising a plurality of windings arranged along a length of a wire guide, the plurality of windings configured to generate magnetic fields to move the wire through the wire guide.

20. The wire feeder of claim 19, further comprising a controller configured to apply an alternating sequence of current to the plurality of windings to generate the magnetic forces along the length of the wire guide.
